(19) United States
(12) Patent Application Publication
(10) Pub. No.: US 2024/0362695 A1
(43) Pub. Date: Oct. 31, 2024

(54) METHOD FOR BROADCASTING MESSAGES IN A WEB-BASED AND APPLICATION BASED PLATFORMS FOR USER DEVICES

(71) Applicant: Lamont Hitchings, Durban (ZA)

(72) Inventor: Lamont Hitchings, Durban (ZA)

(21) Appl. No.: 18/140,021

(22) Filed: Apr. 27, 2023

(51) Int. Cl. G06Q 30/0601; G06Q 50/12

(52) U.S. Cl. CPC G06Q 30/0625; G06Q 30/0611; G06Q 50/12

(57) ABSTRACT

In one aspect, a method for broadcasting to secure accommodations in a marketplace, the method includes selecting a physical accommodation to provide a plurality of inputs including accommodation information, inputting the plurality of inputs into a user interface of a client device of host user, selecting a plurality of dates desired for occupancy of the physical accommodation, generating a broadcast request, including the physical accommodation and the accommodation information, and receiving a broadcast response from a pre-registered occupant user on the specific platform being used based on a plurality of accommodation preferences of the occupant user, the broadcast response including a selection of the accommodation by the occupant user via a user equipment.

### FIELD OF THE TECHNOLOGY

The disclosed technology is related to a broadcast system for a target audience in a software platform. Specifically, the disclosed technology relates to matching multiple parties based on a variety of parameters to provide physical accommodations to a group of people.

### BACKGROUND

Online platforms that offer hotel and house accommodations provide a convenient way for users to book lodging. These platforms have become increasingly popular in recent years, as travelers are looking for better ways to find and book their lodging quickly and easily. By using one of these online platforms, customers can access a variety of places to rent, from room rentals in hotels to short-term apartment or house rentals. Customers can search different types of accommodations, compare prices and amenities, book conveniently online, and often find discounts for their stay. In some instances, customers can perform a property swap with other customers, as well as use a points-based currency as well, instead of traditional fiat currency in order to make the process of an exchange beneficial and equitable for all parties involved.

Online platforms also allow customers to read reviews from other travelers who have stayed at the accommodation before them, giving them better insight into what to expect from their lodging experience. Furthermore, some online platforms have unique features that can help travelers customize their stay, such as providing them with recommendations for nearby attractions or services. By simplifying the entire process of booking lodging, online platforms are becoming an increasingly popular and convenient way to find accommodations. This technology is making it easier than ever before to find a place to stay while traveling. With an ever-growing selection of accommodations and features, online platforms are becoming a powerful tool for locating and booking hotels and house rentals.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

In order to describe the manner in which the above-recited and other advantages and features of the disclosure can be obtained, a more particular description of the principles briefly described above will be rendered by reference to specific examples, which are illustrated in the appended drawings. Understanding that these drawings depict only exemplary examples of the disclosure and are not therefore to be considered to be limiting of its scope, the principles herein are described and explained with additional specificity and detail through the use of the accompanying drawings in which:

FIG. 1 illustrates an example broadcasting system for an accommodation platform, according to some aspects of the disclosure.

FIG. 2 illustrates an example routine of a host user developing a profile of a physical accommodation for broadcasting, according to some aspects of the disclosure.

FIG. 3 illustrates a process for defining a preferred accommodation for an occupant user, according to some aspects of the disclosure.

FIG. 4 illustrates a process for an occupant user to select a broadcast accommodation, according to some aspects of the disclosure.

FIG. 5 shows an example of a system according to some aspects of the disclosure.

FIG. 6 illustrates an example computer system for executing a client application according to some aspects of the disclosure.

### DETAILED DESCRIPTION

Various examples of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an example in the present disclosure can be references to the same example or any example; and, such references mean at least one of the examples.

Reference to “one example” or “an example” means that a particular feature, structure, or characteristic described in connection with the example is included in at least one example of the disclosure. The appearances of the phrase “in one example” in various places in the specification are not necessarily all referring to the same example, nor are separate or alternative examples mutually exclusive of other examples. Moreover, various features are described which can be exhibited by some examples and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various examples given in this specification.

Without intent to limit the scope of the disclosure, examples of instruments, apparatus, methods and their related results according to the examples of the present disclosure are given below. Note that titles or subtitles can be used in the examples for convenience of a reader, which in no way should limit the scope of the disclosure. Unless otherwise defined, technical and scientific terms herein have the meaning commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

### Overview

This invention relates to a broadcast system which facilitates the connection between those seeking accommodations and hosts offering them, without compromising the quality of their brand. This added feature can be implemented on existing accommodation applications and websites, which promote short-term availability of multiple types of lodging establishments via a website or app, using Android, Apple iOS, Huawei or any other mobile operating system or computer browser. Through this system, hosts can broadcast their available rooms in a safe and secure manner, while guests have access to a wide range of options. This patent application seeks to protect this novel approach as a valuable advancement in the field of online platforms for hotel and house accommodations.

In an aspect, a method is disclosed for broadcasting to secure accommodations in a web-based and application based platform is disclosed. In some instances, the various platforms can be initiated in platforms including Android, IOS, Huawei, and any other platform that can be paired with hardware devices including computers and mobile phones that have memory and processors. The method includes selecting a physical accommodation to provide a plurality of inputs including accommodation information. The method includes inputting the plurality of inputs into a user interface of a client device of host user. The method includes selecting a plurality of dates desired for occupancy of the physical accommodation. The method includes generating a broadcast request, including the physical accommodation and the accommodation information. The method includes receiving a broadcast response from an occupant user based on a plurality of accommodation preferences of the occupant user, the broadcast response including a selection of the accommodation by the occupant user via a user equipment.

In one aspect, the broadcast response is based on the occupant user performing the following: selecting a plurality of accommodation preferences for a preferred accommodation; and selecting the preferred accommodation from a plurality of accommodation options based on the accommodation preferences.

In one aspect, the broadcast response includes an acceptance of one or more requirements included in the accommodation information, and at least one incentive associated with the accommodation. The incentive can include a discount, a commission, or points based reward.

In one aspect, the broadcast response is transmitted from the occupant user device, and transmitted based on the selection of a filter comprising one or more of: an accommodation type; a type of property; and a date range.

In one aspect, the broadcast request is transmitted to a plurality of potential occupants that satisfy a predetermined rating value, wherein the predetermined rating value is based on a threshold value associated with previous accommodations by the occupant user, not associated with the physical accommodation. In some examples, the predetermined rating value is based on a threshold value associated with previous accommodations by the occupant user associated with the intended physical accommodation.

In one aspect, the plurality of inputs include at least one of: a maximum distance of travel of the occupant user; a maximum time the occupant user is willing to travel to accept the broadcast request; a property rating above a threshold; a number of people the host user's property can accommodate; a number of rooms available in the accommodation for occupancy by the occupant user and additional occupants; and an expiration value of the broadcast. The expiration of value of the broadcast includes an expiration due to another customer accepting the broadcast request, or a passing of the dates of availability.

In one aspect, the occupant user transmits the broadcast response by: receiving a plurality of broadcasts from a broadcasting platform; filtering the plurality of broadcasts in accordance with a plurality of previously defined settings, including a set of accommodation preferences; and selecting at least one broadcast in the filtered plurality of broadcasts, at least one broadcast including accommodation information of a physical accommodation.

In one aspect, a system for broadcasting to secure accommodations in a web based or application based platform includes a storage (implemented in circuitry) configured to store instructions and a processor is disclosed. In some instances, the various plat forms can be initiated in platforms including Android, IOS, Huawei, and any other platform that can be paired with hardware devices including computers and mobile phones that have memory and processors. The processor configured to execute the instructions and cause the processor to: select a physical accommodation to provide a plurality of inputs including accommodation information; input the plurality of inputs into a user interface of a client device of host user; select a plurality of dates desired for occupancy of the physical accommodation; generate a broadcast request, including the physical accommodation and the accommodation information; and receive a broadcast response from an occupant user based on a plurality of accommodation preferences of the occupant user, the broadcast response including a selection of the accommodation by the occupant user via a user equipment.

In one aspect, a computer readable medium comprising instructions using a computer system is disclosed. The computer includes a memory (e.g., implemented in circuitry) and a processor (or multiple processors) coupled to the memory. The processor (or processors) is configured to execute the computer readable medium and cause the processor to: select a physical accommodation to provide a plurality of inputs including accommodation information; input the plurality of inputs into a user interface of a client device of host user; select a plurality of dates desired for occupancy of the physical accommodation; generate a broadcast request, including the physical accommodation and the accommodation information; and receive a broadcast response from an occupant user based on a plurality of accommodation preferences of the occupant user, the broadcast response including a selection of the accommodation by the occupant user via a user equipment.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

This invention relates to the broadcast system, and it's parameters which enable matches to be made between those wanting accommodation and those offering it without degrading the brand of the establishment by having to publish public discounts. Additionally, the broadcast system can add functionality to an existing accommodation in a mobile application or web-based platform that provides short-term advertising availability of accommodations in various types of accommodation establishments. Platforms that can assist with the presentation of these advertisements via a mobile application can include platform hosts selected from Android, Apple iOS, Huawei, or additional open-source platforms that function with a web browser.

This patent application seeks to protect this novel approach as a valuable innovation in the field of online platforms for hotel and house accommodations. The combination of features and technology described herein will allow users to receive notifications intended to initiate a patron's action of booking lodging in a safe, efficient manner that is currently unavailable on existing online platforms through the providing of a variety of directed incentives associated with host user and occupant user preferences. This patent application provides background information about the current landscape of online platforms for hotel and house rentals and the present disclosure's novel approach to providing an efficient and secure way for users to efficiently locate and identify available accommodations on short notice, with limited time to search, normally under a last minute travel requirement. A host of a property who is looking to attract occupant users that meet their preferences and quality requirements, can be provided only users that meet these parameters to advertise and provide incentives. It will also provide a description of the features and technology that make this disclosure unique from existing online platforms. This patent application will also explain how this invention is an improvement over current methods of booking hotel and house rentals online. Finally, it will provide a discussion of the advantages that users can expect to experience when using this invention.

In summary, the present disclosure is a novel approach to providing users with an efficient and secure way to book their lodging online. By providing a host user and an occupant user with an improved approach to finding quality accommodations and occupants that have mutual and equitable standards of quality. This patent application seeks to protect this novel approach as a valuable innovation in the field of online platforms for hotel and house accommodations. The combination of features and technology described herein will allow users to search, compare, and book lodging quickly and safely in ways that are not currently available on existing online platforms.

This disclosure relates to a broadcast system which facilitates the connection between those seeking accommodations and hosts offering them, without compromising the quality of their brand. This added feature is not available on existing accommodation applications and websites, which promote short-term availability of multiple types of lodging establishments via a website or app, using Android, Apple IOS, Huawei or any other mobile operating system or computer browser. Through this system, hosts can broadcast their available rooms in a safe and secure manner, while guests have access to a wide range of options.

This disclosure provides an advantage for property owners who would traditionally advertise discounts without any focus or efficiency. With no way to determine who to send the offer, it was sent out as a broad broadcast, resulting in email fatigue and frustration from their user base for receiving so many irrelevant promotions. This new system enables them to define their target audience, ensuring that their discounts reach the right customers. The right customer can often be defined through a variety of strategically selected filters that define an occupant preference who would be considered a quality occupant of the hosts' provided accommodations. Thus, the occupant users will receive targeted broadcasts that pertain to the pre-inputted filters. The occupant users subsequently define the type of broadcasts they would like to receive from a variety of hosts. Thus, the system is able to provide a correlated match to the occupant user based on the host's preferences, creating a mutually beneficial approach to matching host accommodations to quality candidates.

Thus the system described herein provides an advantage to property owners and hosts to provide a directly specified broadcast to preferred occupants due to the fact that only relevant occupant users who are willing to stay at that establishment based on their pre-set filters, will receive the broadcast. Further, the host user can set who he wants the broadcast to reach in terms of the quality rating of the occupant user from prior stays at either his establishment or other establishments on a broadcasting platform or additional third-party platforms simultaneously.

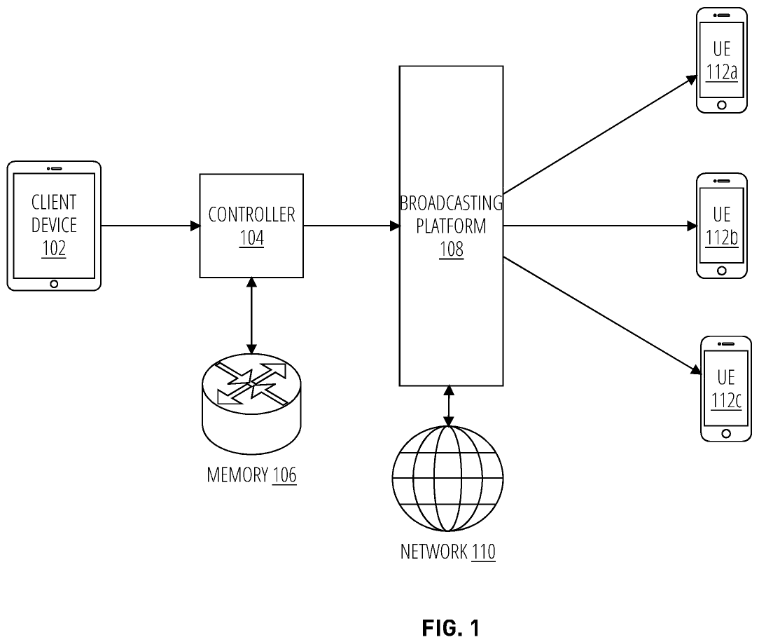

FIG. 1 illustrates an example broadcasting system for an accommodation platform, according to some aspects of the disclosure. The broadcasting system depicted in FIG. 1 in accordance with embodiments of the technology within this disclosure includes a client device 102, a controller 104, a memory 106, a broadcasting platform 108, a network 110, and a plurality of UEs, including UE 112a, UE 112b, and UE 112c.

A host of physical accommodations can interact with a client device 102 to provide a listing of the features of the physical accommodation. A physical accommodation is a term used to refer to any type of physical lodgings, such as a room, house, hotel, or other structurally defined accommodation space. It can also encompass services and amenities associated with the lodging experience. Accommodations are typically rented out on either a short-term or long-term basis. The client device can provide a user with a user interface that allows for digital interaction and receive a plurality of inputs allowing the host to provide details and accommodation information related to the physical accommodation.

A controller 104 can transmit the plurality of inputs and accommodation information input into the client device and process them in preparation for publishing and broadcasting. The controller can communicate with a memory 106 to store the plurality of inputs and accommodation information from the client device 102.

The broadcasting platform 108 can receive the plurality of inputs and accommodation information and prepare them for broadcasting via a network 110 associated with an accommodation platform. The accommodation platform can be embedded within the broadcasting platform 108 and configured to process the plurality of inputs received for access by a plurality of UEs 112a-112c. Each of the UEs can receive a broadcast from the broadcasting platform 108, based on whether or not the users of UE 112a, UE 112b, and UE 112c pre-set filters correlate with the type of physical accommodation broadcast, as well as that their user rating on the existing platform is equal to or more than the rating required and inputted by the host user prior to issuing the broadcast.

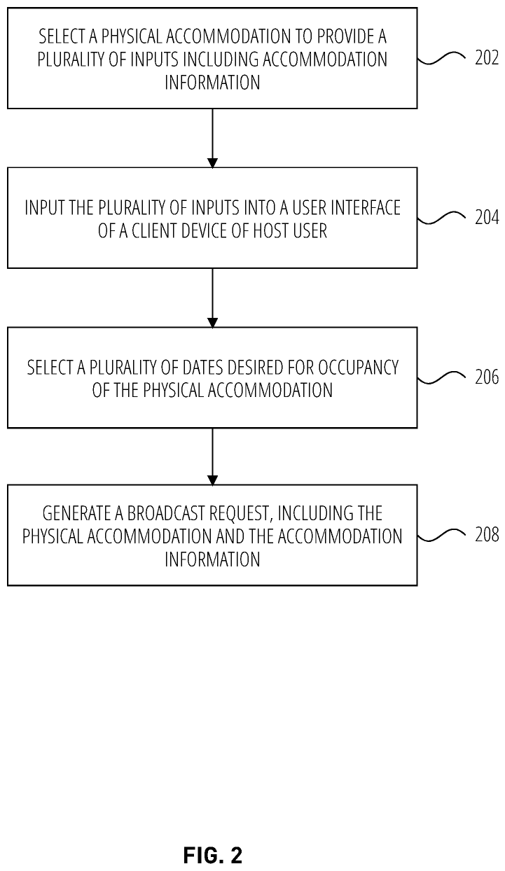

FIG. 2 illustrates an example routine of a host user developing a profile of a physical accommodation for broadcasting, according to some aspects of the disclosure. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes selecting a physical accommodation to provide a plurality of inputs, including accommodation information from a client device of a host of a physical accommodation, at block 202. The client device 102 in FIG. 1 can be any computing device including but not limited to a computer, a mobile device, a tablet, or other user equipment.

According to some examples, the method includes inputting the plurality of inputs into a user interface of a client device of host user at block 204. The host can input various information about the physical accommodation including information about the type of accommodation being offered, such as a whole house or private room, the size and layout of the space; amenities provided, photos of the interior, ratings and reviews from previous guests, descriptions of nearby attractions, restaurants and shopping areas, availability calendar that shows when it is available to rent out, and a list of accommodation rules that guests must abide by. Additionally, some hosts may include additional information such as recommendations for local attractions or tips on how to make the most out of their stay.

According to some examples, the method includes selecting a plurality of dates desired for occupancy of the physical accommodation at block 206.

According to some examples, the method includes generating a broadcast request, including the physical accommodation and the accommodation information at block 208. The broadcast request can include an interaction by the host user with an activation button or indicator in the host user interface that indicates the user is ready to broadcast their accommodation to occupant users that fit the requirements of the physical accommodation. In some examples, the requirements can be input into the host user interface, including the type of occupant they are looking for, amongst various other specifications of the occupant's stay that would be desired for the accommodation. These specifications can include a minimum user rating obtained from previous stays at other accommodations hosted by the the broadcasting platform or other third-party platforms.

Thus, a host user can provide last minute incentives or long-term discounts in the future can be offered to a pre-determined client base without cheapening the brand of the accommodation. This is done using a pre-existing app or website whereby any potential occupant user can register on the app in order to receive these discounts via broadcasts, but they can be called anything by the relevant software platform, application or online travel platform.

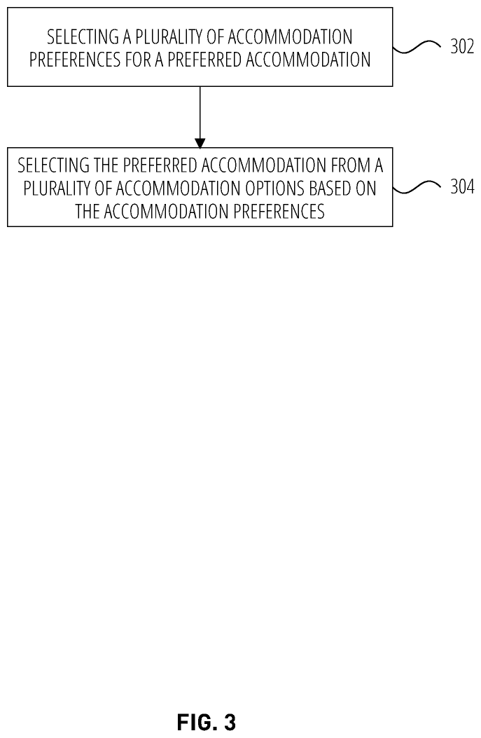

FIG. 3 illustrates a process for defining a preferred accommodation for an occupant user, according to some aspects of the disclosure. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes selecting a plurality of accommodation preferences for a preferred accommodation at block 302. The preferred accommodation can include a set of preferences that define the type of broadcast an occupant user would like to receive, referring to one or more types of accommodations. The preferred accommodations can be set with a wide range of requirements, such as the maximum distance away from the broadcast issuer that a guest is willing to travel (with the option to use either their phone's GPS or a fixed address as reference points), the maximum time they are willing to travel in order to take advantage of the broadcast, a minimum property rating, the number of people that the broadcast is for and the number of rooms available, an expiry date (which can be set to auto-expire), the nightly rack rate offered along with any discounts percentage included in the broadcast, the total price of the stay that a guest is willing to pay, their desired duration of stay regardless of dates, and any discounts on food/drink, spa visits, game drives, etc. All these options give guests maximum flexibility to tailor their broadcast receive settings in order to only receive broadcasts from accommodations satisfying their very focused requirements/filters. according to their individual needs and preferences.

According to some examples, the method includes selecting the preferred accommodation from a plurality of accommodation options based on the accommodation preferences at block 304. In an example, the occupant user can select an accommodation from a list of accommodations in the broadcast.

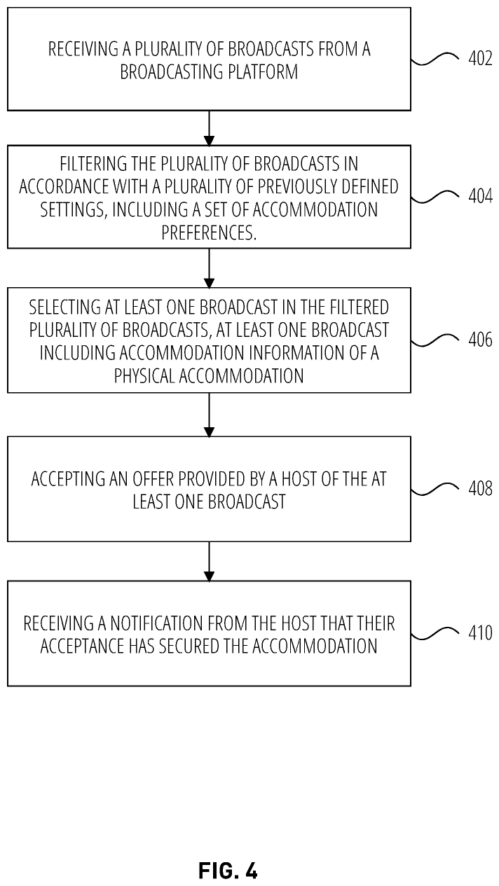

FIG. 4 illustrates a process for an occupant user to select a broadcast accommodation, according to some aspects of the disclosure. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the method includes receiving a plurality of broadcasts from a broadcasting platform at block 402. In an example, the user can receive a plurality of broadcasts that fit the user's preferences in the type of accommodations preferred.

According to some examples, the method includes filtering the plurality of broadcasts in accordance with a plurality of previously defined settings, including a set of accommodation preferences at block 404. The filters can include one or more of a selection of the entire place, a private room, a shared room, or a hotel room and or distance the occupant user is willing to travel in order to take up the broadcast offer.

According to some examples, the method includes selecting at least one broadcast in the filtered plurality of broadcasts, at least one broadcast including accommodation information of a physical accommodation at block 406. In an example, the user can select a broadcast in the plurality of broadcasts that fit the filtered results and the preferred accommodation settings initially set.

According to some examples, the method includes accepting an offer provided by a host of at least one broadcast at block 408. In some examples, the host user can limit guest users who can accept the Broadcast/Shoutout to a certain rating. For example, nobody with a rating of less than 80% or 4 stars out of 5 (for example) will be able to accept the broadcast/Shoutout. This can be publicly shown or automatically processed in the background and a person not meeting the requirements after trying to accept the broadcast will receive an automatically generated error message notifying them of such. In an example, the system can issue a notification stating “Apologies, but we are not able to authorize you to accept this Shoutout/broadcast due to your user rating. Please try and increase your rating up to be able to accept our Shoutouts/broadcasts in the future.”

According to some examples, the method includes receiving a notification from the host that their acceptance has secured the accommodation at block 410. For example, the occupant user can receive an acceptance and a receipt of the transaction with the host.

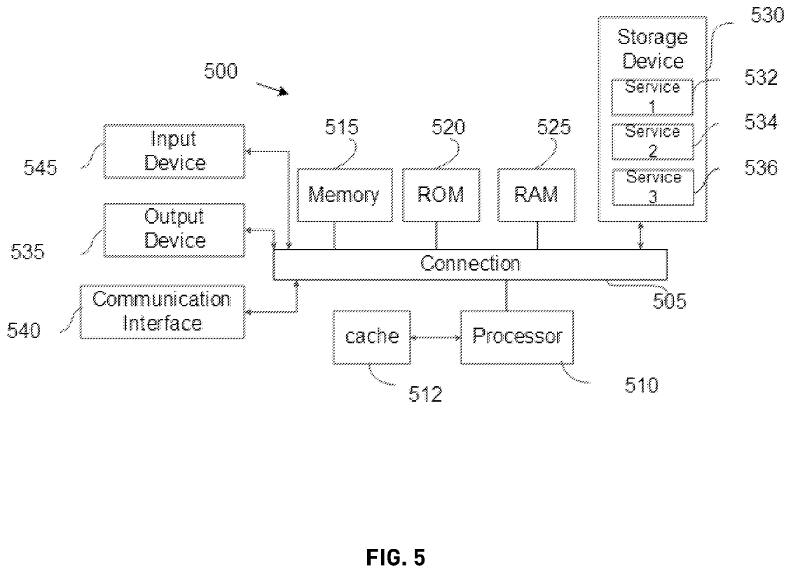

FIG. 5 shows an example of computing system 500, which can be for example any computing device making up any of the elements of FIG. 1, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random access memory (RAM) 525 to processor 510. Computing system 500 can include a cache of high-speed memory 512 connected directly with, in close proximity to, or integrated as part of processor 510.

Processor 510 can include any general purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. There is no restriction on operating on any particular hardware arrangement, and therefore the basic features here may easily be substituted for improved hardware or firmware arrangements as they are developed including Artificial Intelligence.

Storage device 530 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices including Artificial Intelligence.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

For clarity of explanation, in some instances, the present technology may be presented as including individual functional blocks including functional blocks comprising devices, device components, steps or routines in a method embodied in software, or combinations of hardware and software, Artificial Intelligence or other machine learning capabilities.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

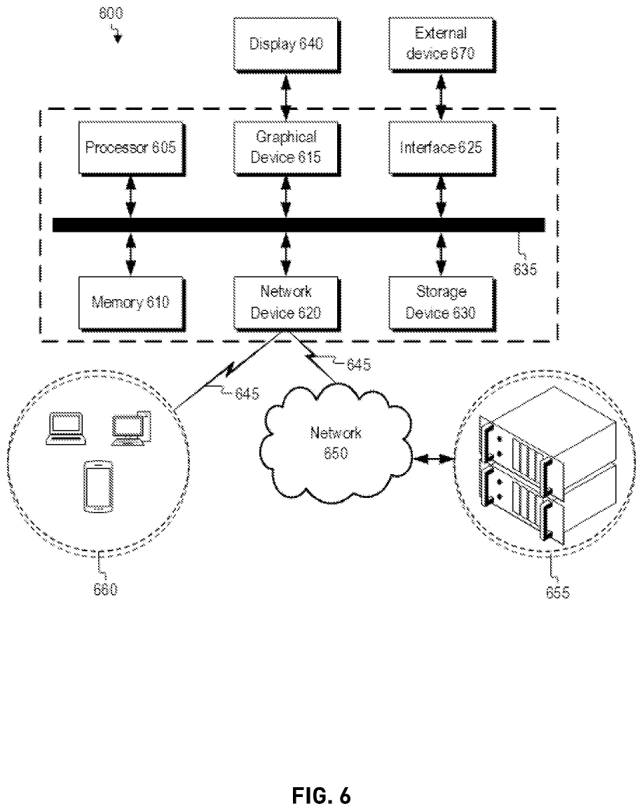

FIG. 6 illustrates an example computer system 600 for implementing a part of the instant disclosure. For example, the example computer system 600 may execute a client application for performing the embodiments discussed within this disclosure.

The example computer system 600 includes a processor 605, a memory 610, a graphical device 615, a network device 620, interface 625, and a storage device 630 that are connected to operate via a bus 635. The processor 605 reads causes machine instructions (e.g., reduced instruction set (RISC), complex instruction set (CISC), etc.) that are loaded into the memory 610 via a bootstrapping process and executes an operating system (OS) for executing application within frameworks provided by the OS. For example, the processor 605 may execute an application that executes an application provided by a graphical framework such as Winforms, Windows Presentation Foundation (WPF), Windows User Interface (WinUI), or a cross platform user interface such as Xamarin or QT. In other examples, the processor 605 may execute an application that is written for a sandbox environment such as a web browser.

The processor 605 controls the memory 610 to store instructions, user data, OS content, and other content that cannot be stored within the processor 605 internally (e.g., within the various caches). The processor 605 may also control a graphical device 615 (e.g., a graphical processor) that outputs graphical content to a display 640. In some example, the graphical device 615 may be integral within the processor 605. In yet another example, the display 640 may be integral with the computer system 600 (e.g., a laptop, a tablet, a phone, etc.).

The graphical device 615 may be optimized to perform floating point operations such as graphical computations, and may be configured to execute other operations in place of the processor 605. For example, controlled by instructions to perform mathematical operations optimized for floating point math. For example, the processor 605 may allocate instructions to the graphical device 615 for operations that are optimized for the graphical device 615. For instance, the graphical device 615 may execute operations related to artificial intelligence (AI), natural language processing (NLP), vector math. The results may be returned to the processor 605. In another example, the application executing in the processor 605 may provide instructions to cause the processor 605 to request the graphical device 615 to perform the operations. In other examples, the graphical device 615 may return the processing results to another computer system (i.e, distributed computing).

The processor 605 may also control a network device 620 for transmits and receives data using a plurality of wireless channels 645 and at least one communication standard (e.g., Wi-Fi (i.e., 802.11ax, 802.11e, etc), Bluetooth®, various standards provided by the 3rd Generation Partnership Project (e.g., 3G, 4G, 5G), or a satellite communication network (e.g., Starlink). The network device 620 may wirelessly connect to a network 650 to connect to servers 655 or other service providers. The network device 620 may also be connected to the network 650 via a physical (i.e., circuit) connection. The network device 620 may also directly connect to local electronic device 660 using a point-to-point (P2P) or a short range radio connection.

The processor 605 may also control an interface 625 that connects with an external device 670 for bidirectional or unidirectional communication. The interface 625 is any suitable interface that forms a circuit connection and can be implemented by any suitable interface (e.g., universal serial bus (USB), Thunderbolt, and so forth). The external device 665 is able to receive data from the interface 625 to process the data or perform functions for different applications executing in the processor 605. For example, the external device 665 may be another display device, a musical instrument, a computer interface device (e.g., a keyboard, a mouse, etc.), an audio device (e.g., an analog-to-digital converter (ADC), a digital-to-analog converter (DAC)), a storage device for storing content, an authentication device, an external network interface (e.g., a 5G hotspot), a printer, and so forth.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

Aspect 1. A method for broadcasting to secure accommodations in a marketplace, the method comprising: selecting a physical accommodation to provide a plurality of inputs including accommodation information; inputting the plurality of inputs into a user interface of a client device of host user; selecting a plurality of dates desired for occupancy of the physical accommodation; generating a broadcast request, including the physical accommodation and the accommodation information; and receiving a broadcast response from an occupant user based on a plurality of accommodation preferences of the occupant user, the broadcast response including a selection of the accommodation by the occupant user via a user equipment.

Aspect 2. The method of Aspect 1, wherein the broadcast response is based on the occupant user performing the following: selecting a plurality of accommodation preferences for a preferred accommodation; and selecting the preferred accommodation from a plurality of accommodation options based on the accommodation preferences.

Aspect 3. The method of any of Aspects 1 to 2, wherein the broadcast response includes an acceptance of one or more requirements included in the accommodation information, and at least one incentive associated with the accommodation, wherein the at least one incentive can be a discount offered.

Aspect 4. The method of any of Aspects 1 to 3, wherein the broadcast response is transmitted from the occupant user device, and transmitted based on receiving a broadcast upon satisfying one or more prior selections of filters comprising one or more of: an accommodation type; a type of property; a date range, and a distance willing to travel.

Aspect 5. The method of any of Aspects 1 to 4, wherein the broadcast request is transmitted to a plurality of potential occupants that satisfy a predetermined rating value, wherein the predetermined rating value is based on a threshold value associated with previous accommodations by the occupant use.

Aspect 6. The method of any of Aspects 1 to 5, wherein the plurality of inputs include at least one of: a maximum distance of travel of the occupant user; a maximum time the occupant user is willing to travel to accept the broadcast request; a property rating above a threshold; a number of rooms available in the accommodation for occupancy by the occupant user and additional occupants; and an expiration value of the broadcast upon acceptance by another user.

Aspect 7. The method of any of Aspects 1 to 6, wherein the occupant user transmits the broadcast response by: receiving a plurality of broadcasts from a broadcasting platform; filtering the plurality of broadcasts in accordance with a plurality of previously defined settings, including a set of accommodation preferences; and selecting at least one broadcast in the filtered plurality of broadcasts, at least one broadcast including accommodation information of a physical accommodation.

Aspect 8. A system for broadcasting to secure accommodations in a web based platform including one or more of Android, IOS, Huawei and any other platform used on computers and mobile phones and devices to perform the interaction of exchanging or paying a fee, includes a storage (implemented in circuitry) configured to store instructions and a processor. The processor configured to execute the instructions and cause the processor to: select a physical accommodation to provide a plurality of inputs including accommodation information; input the plurality of inputs into a user interface of a client device of host user; select a plurality of dates desired for occupancy of the physical accommodation; generate a broadcast request, including the physical accommodation and the accommodation information; and receive a broadcast response from an occupant user based on a plurality of accommodation preferences of the occupant user, the broadcast response including a selection of the accommodation by the occupant user via a user equipment.

Aspect 9. The system of Aspect 8, wherein the broadcast response is based on the occupant user performing the following: select a plurality of accommodation preferences for a preferred accommodation; and select the preferred accommodation from a plurality of accommodation options based on the accommodation preferences.

Aspect 10. The system of any of Aspects 8 to 9, wherein the broadcast response includes an acceptance of one or more requirements included in the accommodation information, and at least one incentive associated with the accommodation.

Aspect 11. The system of any of Aspects 8 to 10, wherein the broadcast response is transmitted from the occupant user device, and transmit based on the pre-selection of filters comprising one or more of and distance from the host user's accommodation selection of a filter comprising one or more of: an accommodation type; a type of property; and a date range.

Aspect 12. The system of any of Aspects 8 to 11, wherein the broadcast request is transmitted to a plurality of potential occupants that satisfy a predetermined rating value, wherein the predetermined rating value is based on a threshold value associated with previous accommodations by the occupant user, not associated with the physical accommodation.

Aspect 13. The system of any of Aspects 8 to 12, wherein the plurality of inputs include at least one of: a maximum distance of travel of the occupant user; a maximum time the occupant user is willing to travel in order to accept the broadcast request; a property rating above a threshold; a number of rooms available in the accommodation for occupancy by the occupant user and additional occupants; and an expiration value of the broadcast.

Aspect 14. The system of any of Aspects 8 to 13, wherein the occupant user transmits the broadcast response by: receive a plurality of broadcasts from a broadcasting platform; filter the plurality of broadcasts in accordance with a plurality of previously defined settings, including a set of accommodation preferences; and selecting at least one broadcast in the filtered plurality of broadcasts, at least one broadcast including accommodation information of a physical accommodation.

Aspect 15. A non-transitory computer readable medium comprising instructions using a computer system. The computer includes a memory (e.g., implemented in circuitry) and a processor (or multiple processors) coupled to the memory. The processor (or processors) is configured to execute the computer readable medium and cause the processor to: select a physical accommodation to provide a plurality of inputs including accommodation information; input the plurality of inputs into a user interface of a client device of host user; select a plurality of dates desired for occupancy of the physical accommodation; generate a broadcast request, including the physical accommodation and the accommodation information; and receive a broadcast response from an occupant user based on a plurality of accommodation preferences of the occupant user, the broadcast response including a selection of the accommodation by the occupant user via a user equipment.

Aspect 16. The non-transitory computer readable medium of Aspect 15, wherein the broadcast response is based on the occupant user having previously set his receive broadcast filters to only receive certain broadcasts that match his predefined filters performing the following: select a plurality of accommodation preferences for a preferred accommodation; and select the preferred accommodation from a plurality of accommodation options based on the accommodation preferences.

Aspect 17. The non-transitory computer readable medium of any of Aspects 15 to 16, wherein the broadcast response includes an acceptance of one or more requirements included in the accommodation information, and at least one incentive associated with the accommodation.

Aspect 18. The non-transitory computer readable medium of any of Aspects 15 to 17, wherein the broadcast response is transmitted from the occupant user device, and transmit based on the selection of a filter comprising one or more of: an accommodation type; a type of property; and a date range and/or distance he is willing to travel.

Aspect 19. The non-transitory computer readable medium of any of Aspects 15 to 18, wherein the broadcast request is transmitted to a plurality of potential occupants that satisfy a predetermined rating value, wherein the predetermined rating value is based on a threshold value associated with previous accommodations where the occupant user has previously stayed and received guest ratings on his profile.

Aspect 20. The non-transitory computer readable medium of any of Aspects 15 to 19, wherein the plurality of inputs include at least one of: a maximum distance of travel of the occupant user; a maximum time the occupant user is willing to travel to accept the broadcast request; a property rating above a threshold; a number of rooms available in the accommodation for occupancy by the occupant user and any additional occupants (if any); and an expiration value of the broadcast.

Aspect 21. The non-transitory computer readable medium of any of Aspects 15 to 20, wherein the occupant user transmits the broadcast response by: receive a plurality of broadcasts from a broadcasting platform; filter the plurality of broadcasts in accordance with a plurality of previously defined settings, including a set of accommodation preferences; and selecting at least one broadcast in the filtered plurality of broadcasts, at least one broadcast including accommodation information of a physical accommodation.

What is claimed is:

1. A method for broadcasting to secure accommodations in a software platform for a client device, the method comprising:
selecting a physical accommodation to provide a plurality of inputs including accommodation information;
inputting the plurality of inputs into a user interface of the client device of host user;
selecting a plurality of dates desired for occupancy of the physical accommodation;
generating a broadcast request, including the physical accommodation and the accommodation information; and
receiving a broadcast response from an occupant user based on a plurality of accommodation preferences of the occupant user, the broadcast response including a selection of the accommodation by the occupant user via a user equipment.

2. The method of claim 1, wherein the broadcast response is based on the occupant user performing the following prior to the broadcast being received:
selecting a plurality of accommodation preferences for a preferred accommodation; and
selecting the preferred accommodation from a plurality of accommodation options based on the accommodation preferences.

3. The method of claim 1, wherein the broadcast response includes an acceptance of one or more requirements included in the accommodation information, and at least one incentive associated with the accommodation, wherein the at least one incentive can be a discount offered.

4. The method of claim 1, wherein the broadcast response is transmitted from the occupant user device, and transmitted based on receiving a broadcast upon satisfying one or more prior selections of filters comprising one or more of:
an accommodation type;
a type of property;
a date range;
a daily rack rate; and
a distance the occupant user is willing to travel.

5. The method of claim 1, wherein the broadcast request is transmitted to a plurality of potential occupants that satisfy a predetermined rating value, wherein the predetermined rating value is based on a threshold value associated with previous accommodations by the occupant user.

6. The method of claim 1, wherein the plurality of inputs include at least one of:
a maximum distance of travel preferred by the occupant user;
a maximum time the occupant user is willing to travel to accept the broadcast request;
a property rating equal to or above a threshold;
a number of rooms available in the accommodation for occupancy by the occupant user and any additional occupants associated with the occupant user;
an expiration value of the broadcast upon acceptance by another user;
a daily rack rate of the property; and
a price range the occupant user is willing to pay.

7. The method of claim 1, wherein the occupant user transmits the broadcast response by:
receiving a plurality of broadcasts from a broadcasting platform;
filtering the plurality of broadcasts in accordance with a plurality of previously defined settings, including a set of accommodation preferences; and
selecting at least one broadcast in the filtered plurality of broadcasts, at least one broadcast including accommodation information of a physical accommodation.

8. A system for broadcasting to secure accommodations in a software platform for a client device, comprising:
a storage configured to store instructions;
a processor configured to execute the instructions and cause the processor to:
select a physical accommodation to provide a plurality of inputs including accommodation information;
input the plurality of inputs into a user interface of the client device of host user;
select a plurality of dates desired for occupancy of the physical accommodation;
generate a broadcast request, including the physical accommodation and the accommodation information and a minimum guest rating required; and
receive a broadcast response from an occupant user based on a plurality of accommodation preferences of the occupant user, the broadcast response including a selection of the accommodation by the occupant user via a user equipment.

9. The system of claim 8, wherein the broadcast response is based on the occupant user performing the following prior to the broadcast being received:
select a plurality of accommodation preferences for a preferred accommodation; and
select the preferred accommodation from a plurality of accommodation options based on the accommodation preferences.

10. The system of claim 8, wherein the broadcast response includes an acceptance of one or more requirements included in the accommodation information, and at least one incentive associated with the accommodation, wherein the at least one incentive can be a discount offered.

11. The system of claim 8, wherein the broadcast response is transmitted from the occupant user device, and transmit based on receiving a broadcast upon satisfying one or more prior selections of filters comprising one or more of:
an accommodation type;
a type of property;
a date range;
a daily rack rate; and
a distance the occupant user is willing to travel.

12. The system of claim 8, wherein the broadcast request is transmitted to a plurality of potential occupants that satisfy a predetermined rating value, wherein the predetermined rating value is based on a threshold value associated with previous accommodations by the occupant user.

13. The system of claim 8, wherein the plurality of inputs includes at least one of:
a maximum distance of travel preferred by the occupant user;
a maximum time the occupant user is willing to travel to accept the broadcast request;
a property rating equal to or above a threshold;
a number of rooms available in the accommodation for occupancy by the occupant user and any additional occupants associated with the occupant user;
an expiration value of the broadcast upon acceptance by another user;
a daily rack rate of the property; and
a price range the occupant user is willing to pay.

14. The system of claim 8, wherein the occupant user transmits the broadcast response by:
receiving a plurality of broadcasts from a broadcasting platform;
filtering the plurality of broadcasts in accordance with a plurality of previously defined settings, including a set of accommodation preferences; and
selecting at least one broadcast in the filtered plurality of broadcasts, at least one broadcast including accommodation information of a physical accommodation.

15. A non-transitory computer readable medium comprising instructions, the instructions, when executed by a computing system, cause the computing system to:
select a physical accommodation to provide a plurality of inputs including accommodation information;
input the plurality of inputs into a user interface of a client device of host user;
select a plurality of dates desired for occupancy of the physical accommodation;
select a minimum user rating of occupant user who can accept the broadcast;
generate a broadcast request, including the physical accommodation and the accommodation information; and
receive a broadcast response from an occupant user based on a plurality of accommodation preferences of the occupant user, the broadcast response including a selection of the accommodation by the occupant user via a user equipment.

16. The non-transitory computer readable medium of claim 15, wherein the broadcast response is based on the occupant user performing the following prior to the broadcast being received:
select a plurality of accommodation preferences for a preferred accommodation; and
select the preferred accommodation from a plurality of accommodation options based on the accommodation preferences.

17. The non-transitory computer readable medium of claim 15, wherein the broadcast response includes an acceptance of one or more requirements included in the accommodation information, and at least one incentive associated with the accommodation, wherein the at least one incentive can be a discount offered.

18. The non-transitory computer readable medium of claim 15, wherein the broadcast request is transmitted to a plurality of potential occupants that satisfy a predetermined rating value, wherein the predetermined rating value is based on a threshold value associated with previous accommodations by the occupant user.

19. The non-transitory computer readable medium of claim 15, wherein the plurality of inputs include at least one of:
a maximum distance of travel preferred by the occupant user;
a maximum time the occupant user is willing to travel to accept the broadcast request;
a property rating equal to or above a threshold;
a number of rooms available in the accommodation for occupancy by the occupant user and any additional occupants associated with the occupant user;
an expiration value of the broadcast upon acceptance by another user;
a daily rack rate of the property; and
a price range the occupant user is willing to pay.

20. The non-transitory computer readable medium of claim 15, wherein the occupant user transmits the broadcast response by:
receiving a plurality of broadcasts from a broadcasting platform;
filtering the plurality of broadcasts in accordance with a plurality of previously defined settings, including a set of accommodation preferences; and
selecting at least one broadcast in the filtered plurality of broadcasts, at least one broadcast including accommodation information of a physical accommodation.
